(19) United States
(12) Patent Application Publication
(10) Pub. No.: US 2002/0067505 A1
(43) Pub. Date: Jun. 6, 2002

(54) Image processing apparatus and method

(76) Inventor: Tetsuo Ogushi, Fukuoka (JP)

Correspondence Address: RATNER AND PRESTIA, One Westlakes, Berwyn, Suite 301, P.O. Box 980, Valley Forge, PA, 19482-0700, US

(21) Appl. No.: 09/963,312

(22) Filed: Sep. 26, 2001

(30) Foreign Application Priority Data
Sep. 28, 2000 (JP) 2000-296292

(51) Int. Cl. B41J 1/00; G06F 15/00

(52) U.S. Cl. 358/1.15; 358/1.18

(57) ABSTRACT

The image processing apparatus and method for interpreting the printing data, and developing the data into bit map data in every drawing band unit. An upside-down print setting unit sets upside-down printing for printing by reversing the data from the end drawing band to the head band. A band selecting unit selects a drawing band based upon the information from the upside-down print setting unit while referring to a link list having arrangement information of plural drawing bands. A compression direction determining unit determines the sequence of compression of bit map data in the drawing bands based upon the information from the upside-down print setting unit. A data compressing unit compresses the data of the selected drawing band according to the determined sequence. This apparatus is applicable to variable length compression method because the data inversion is executed simultaneously with compression process in drawing band unit.

### FIELD OF THE INVENTION

The present invention relates to an image processing apparatus and method for a printing machine or the like for forming images based on stored image data.

### BACKGROUND OF THE INVENTION

When a printing machine receives printing data from a host computer and prints, the data is once stored in a memory. For example, an image processing apparatus receives printing data sequentially transferred from the host computer, interprets the printing data, develops it into a bit map in drawing band units, and compresses the bit map data and stores in the memory. At this time, the data is stored in the memory as being compressed in plural drawing bands sequentially from the head drawing band.

A conventional process of printing the stored data is explained.

When printing the data upside down, that is, in the case of so-called upside-down printing, this image processing apparatus decompresses, as shown in FIG. 14, while selecting drawing bands sequentially from the data of the end drawing band stored in a memory 50.

Herein, an arrow 52 shows a direction of compression, and an arrow 54 indicates a direction of decompression.

At this time, in a compressed drawing band 56 shown in FIG. 15, the compressed data is decompressed and printed sequentially from an end address 64 of the selected drawing band. Thus, the data is printed upside down.

An arrow 58 represents a main-scanning direction. An arrow 60 denotes a sub-scanning direction. An arrow 62 indicates a direction of decompression.

In the case of mirror-reversed printing of data, as shown in FIG. 16, the image processing apparatus decompresses the data compressed and stored in the memory 50 sequentially from the head drawing band, while selecting drawing bands sequentially from the head drawing band.

Herein, an arrow 66 shows a direction of compression, and an arrow 68 indicates a direction of decompression.

At this time, in a compressed drawing band 78 shown in FIG. 17, the compressed data is decompressed and printed sequentially from a line end address 76 in every main scanning line of drawing bands. Thus, the data is printed by mirror reversing.

An arrow 72 represents a main-scanning direction. An arrow 70 denotes a sub-scanning direction. An arrow 74 indicates a direction of decompression.

Recently, as the printing data is diversified and complicated, improvement of rate of compression is demanded, and the method of compression is also diversified. In the conventional method, however, the compressed data is decompressed from the end address. Accordingly, for example, the conventional image processing apparatus is not able to use a variable length compression method in which the band end address or line end address cannot be specified at the beginning of process.

### SUMMARY OF THE INVENTION

It is hence an object of the invention to present an image processing apparatus and method applicable to variable length compression method by reversing the data in upside-down printing or mirror-reversed printing simultaneously with compression in drawing band units.

The image processing apparatus of the invention interprets the printing data, and develops it into bit map data of plural drawing bands. In this apparatus, an upside-down print setting unit sets upside-down printing for reversed printing the data from the end drawing band to the head band.

A band selecting unit selects a drawing band based on the information from the upside-down print setting unit while referring to a link list having arrangement information of plural drawing bands. A compression detection determining unit determines the sequence of compression of bit map data in the drawing bands based on the information from the upside-down print setting unit. A data compressing unit compresses the data of drawing bands selected by the band selecting unit according to the sequence determined by the compression direction determining unit.

The image processing apparatus of the invention also includes a mirror-reversed print setting unit, and is applicable also to mirror-reversed print for decompressing and printing compressed data sequentially from the line end address of drawing bands.

The band selecting unit can also select a drawing band by referring to the header or footer of the drawing band.

The image processing method of the invention interprets the printing data, and develops it into bit map data of plural drawing bands. This method comprises the following steps.

(a) The upside-down print is set for printing by reversing the data from the end drawing band to the head drawing band.

(b) A drawing band is selected based on setting of upside-down print, while referring to a link list having arrangement information of plural drawing bands.

(c) The sequence of compression of bit map data in the drawing bands is determined based on setting of upside-down print.

(d) Data of selected drawing bands are compressed according to the sequence of compression.

### BRIEF DESCRIPTION OF THE DRAWINGS

FIG. 1 is a block diagram of an image processing apparatus in embodiment 1 of the invention.

FIG. 2 is a storage map of band data and link list in embodiment 1 of the invention.

FIG. 3 is a block diagram of data compressing unit provided in the image processing apparatus in embodiment 1 of the invention.

FIG. 4 shows a bit arrangement conversion in the data compressing unit in embodiment 1 of the invention.

FIG. 5 shows upside-down reversed drawing bands in the data compressing unit in embodiment 1 of the invention.

FIG. 6 is a flowchart of the image processing apparatus in embodiment 1 of the invention.

FIG. 7 is a block diagram of an image processing apparatus in embodiment 2 of the invention.

FIG. 8 is an explanatory diagram of link list in embodiment 2 of the invention.

FIG. 9 is a block diagram of an image processing apparatus in embodiment 3 of the invention.

FIG. 10 shows mirror-reversed drawing bands in a data compressing unit provided in the image processing apparatus in embodiment 3 of the invention.

FIG. 11 is a block diagram of an image processing apparatus in embodiment 4 of the invention.

FIG. 12 is a storage map of band data and header in embodiment 4 of the invention.

FIG. 13 is a block diagram of an image processing apparatus in embodiment 5 of the invention.

FIG. 14 shows a band processing sequence in upside-down print in a conventional image processing apparatus.

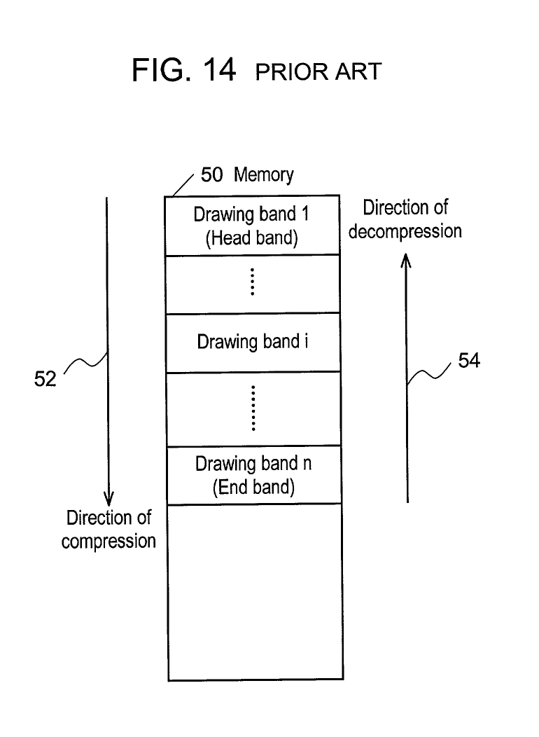

FIG. 15 shows the direction of decompression of data in band in upside-down print in the conventional image processing apparatus.

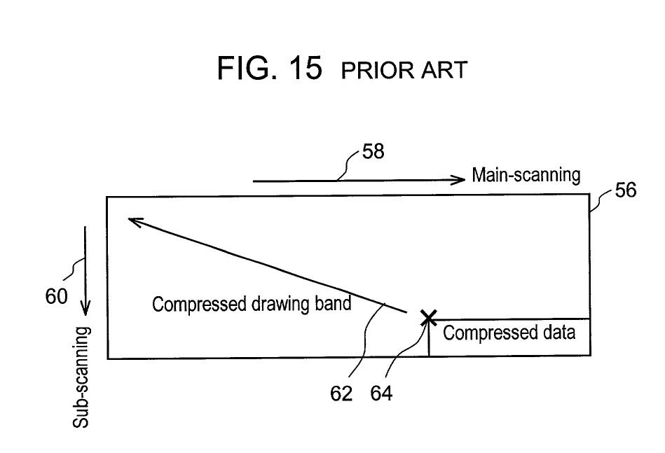

FIG. 16 shows a band processing sequence in mirror-reversed print in a conventional image processing apparatus.

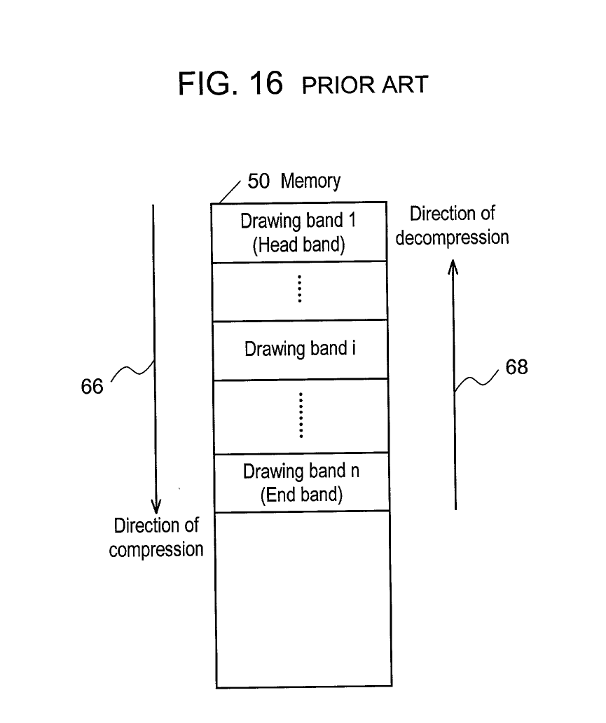

FIG. 17 shows the direction of decompression of data in band in mirror-reversed print in the conventional image processing apparatus.

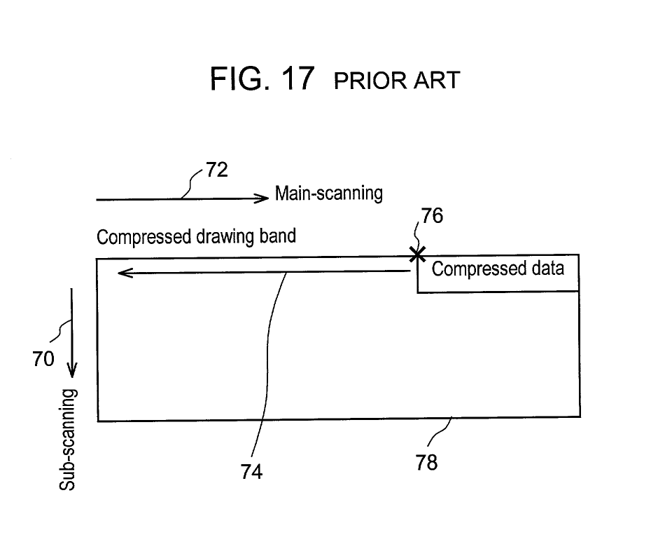

### DESCRIPTION OF THE PREFERRED EMBODIMENTS

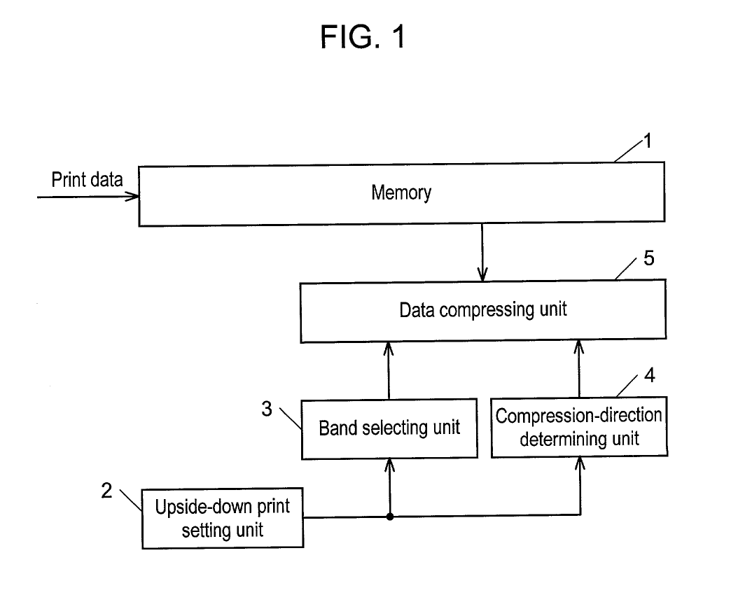

Preferred embodiments of the invention are described while referring to FIG. 1 to FIG. 13. Throughout the drawings, the same reference numerals are given to the same elements and duplicate explanation is omitted.

(Embodiment 1)

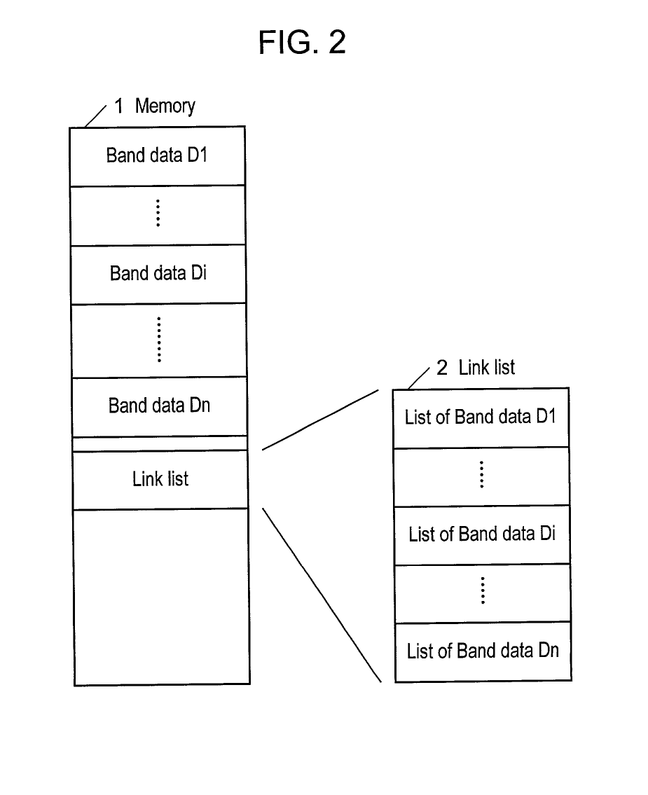

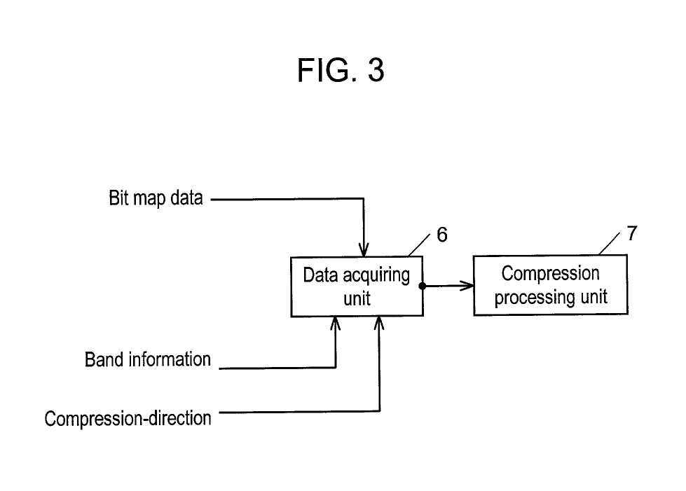

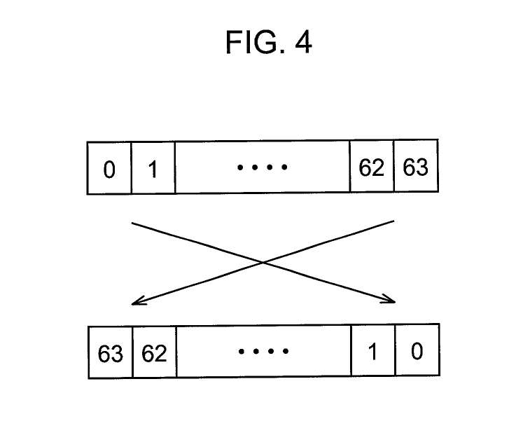

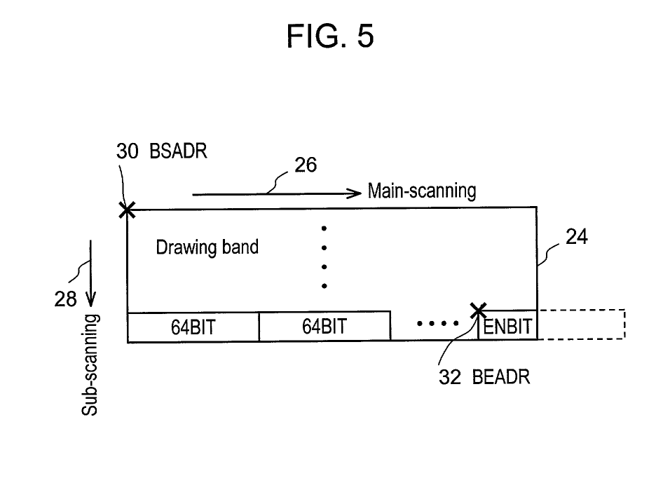

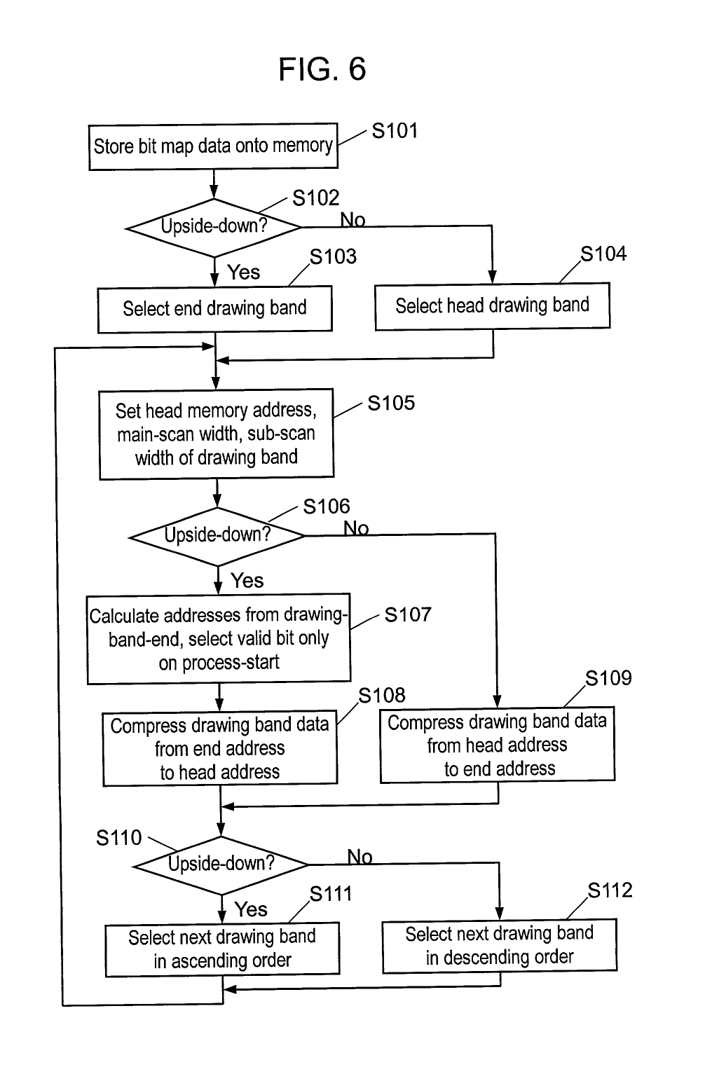

FIG. 1 is a block diagram of an image processing apparatus in embodiment 1 of the invention, FIG. 2 is a storage map of band data and link list of the same, FIG. 3 is a block diagram of data compressing unit provided in the image processing apparatus, FIG. 4 is an explanatory diagram showing a bit arrangement conversion in the data compressing unit, FIG. 5 is an explanatory diagram showing upside-down reversed drawing bands in the data compressing unit, and FIG. 6 is a flowchart of the image processing apparatus.

In embodiment 1, the image processing apparatus develops the printing data transferred from the host computer or the like into a bit map in every drawing band unit, and the bit map data is compressed and stored in the memory.

The image processing apparatus includes a memory 1, an upside-down print setting unit 2, a band selecting unit 3, a compression direction determining unit 4, and a data compressing unit 5. The memory 1, band selecting unit 3, and compression direction determining unit 4 are connected to the data compressing unit 5. The upside-down print setting unit 2 is connected to the band selecting unit 3 and compression direction determining unit 4.

Entered printing data is sequentially transferred to the memory 1. The memory 1 temporarily stores the printing data.

Whether upside-down print is done or not is set in the upside-down print setting unit 2.

The band selecting unit 3 determines the sequence of drawing bands to be processed out of the plural drawing bands. Further, the band selecting unit 3, while referring to the link list according to the sequence, issues the band information of the selected drawing band, more specifically the information of memory head address in which the band data is stored, and main scanning width and sub scanning width, to the data compressing unit 5.

The data compressing unit 5 compresses the bit map data based on the information issued from the band selecting unit 3 and compression direction determining unit 4.

The compression direction determining unit 4 determines whether the data compression is started from the head data or from the end data in the drawing band, based on the information from the upside-down print setting unit 2, and issues the determined compression direction to the data compressing unit 5.

Printing data sequentially transferred from an external device is once stored in the memory 1. Then, a rasterizer takes out the printing data stored in the memory 1 sequentially, and develops it into bit map data. At this time, the printing data is developed into bit map data of each one of plural drawing bands by the rasterizer. As shown at the left side in FIG. 2, the bit map data developed again is stored in the memory 1 as band data D1 to band data Dn. At this time, the attribute of each drawing band required in a later process is stored in the memory 1.

Herein, the memory head address which is the attribute of each drawing band, main scanning width, and sub scanning width are compiled as a list, and held in batch as a form of a link list 22 piling up lists as shown at the right side in FIG. 2.

According to the instruction from the upside-down print setting unit 2 setting whether or not to print by turning upside down, the band selecting unit 3 determines the sequence of drawing bands to be processed out of the plural drawing bands. Further, the band selecting unit 3, while referring to the link list according to the sequence, issues the band information of the selected drawing bands, more specifically the information of memory head address, main scanning width and sub scanning width of the memory in which the band data is stored, to the data compressing unit 5.

According to the information from the upside-down print setting unit 2, the compression direction determining unit 4 determines whether the compression of data is started from the head data or from the end data in the drawing band, and issues the determined compression direction to the data compressing unit 5.

The data compressing unit 5 compresses the bit map data based on the information from the band selecting unit 3 and compression direction determining unit 4.

The data compressing unit 5 specifically described by referring to FIG. 3.

The data compressing unit 5 includes a data acquiring unit 6 and a compression processing unit 7. The data acquiring unit 6 determines the reading address of the memory 1 based on the band information and compression direction, and acquires data from the memory 1. The compression processing unit 7 compresses the data received from the data acquiring unit 6.

For example, when the compression direction is from the head data, the data acquiring unit 6 determines the memory reading address while incrementing the address sequentially from the head address based on the information about the band, and acquires data from the memory 1. Further, the data acquiring unit 6 sequentially issues the acquired data to the compression processing unit 7.

When the compression direction is from the end data, the data acquiring unit 6 calculates the end address from the beginning address, main scanning width and sub scanning width, of the band information. Further, the data acquiring unit 6 determines the memory reading address while incrementing the address sequentially from the end address, and acquires data from the memory. Moreover, the data acquiring unit 6 converts the bit sequence, and issues the data sequentially to the compression processing unit 7.

Herein, calculation of end address and conversion of bit sequence are executed as follows.

In the memory 1, as shown in FIG. 4, data is handled in 64-bit data width. As shown in FIG. 5, in the memory 1, a head address 30 of a drawing band 24 is BSADR, an end address 32 of the drawing band 24 is BEADR, the main scanning width of the drawing band 24 is WIDTH, and the sub scanning width of the drawing band 24 is HEIGHT. The bit map data is supposed to be stored in the memory in plane sequence in each color. Herein, an arrow 26 shows the main-scanning direction, and an arrow 28 indicates a sub-scanning direction.

BEADR is calculated in formula 1.

BEADR=BSADR+{(WIDTH×HEIGHT)/64}×8−1 (1)

where the division result of WIDTH×HEIGHT/64 is obtained as an integer by rounding up the decimal, while the remainder of the division result is held as ENBIT.

For conversion of bit sequence, the data acquiring unit 6 reverses the arrangement of data acquired from the memory as shown in FIG. 4. Further, the data acquiring unit 6, as shown in FIG. 5, issues the value of ENBIT to the compression processing unit 7 as the significant bit data from the 64-bit data acquired upon the start of processing.

The compression processing unit 7 sequentially compresses the data from the data acquiring unit 6. At this time, the compression processing unit 7 selects significant bits according to the ENBIT value from the data acquiring unit 6 only upon start of processing, and compresses on the selected data alone. The method of compression is the conventional arithmetic coding or the like, and its explanation is omitted.

The operation of the image processing apparatus in embodiment 1 is explained below by referring to the flowchart in FIG. 6.

First, the printing data is sequentially interpreted by the rasterizer, and the printing data is judged to correspond to which drawing band of the plural drawing bands, and the data is developed into bit map data, and stored onto the memory (step S101).

According to the setting of the upside-down print setting unit 2, the band selecting unit 3 judges whether or not to turn the printing data upside down (step S102).

When turning upside down, the band selecting unit 3 selects the end drawing band out of the plural drawing bands as the object band (step S103).

When not turning upside down, the head drawing band out of the plural drawing bands is selected as the object band (step S104).

Next, the band selecting unit 3 transfers the information of the memory head address, main scanning width and sub scanning width, of the memory in which the drawing band of the selected object band is stored, to the data compressing unit 5. The data compressing unit 5 sets these values (step S105).

Further, the compression direction determining unit 4 judges whether to turn upside down or not (step S106).

When turning upside down, the compression direction determining unit 4 sends an instruction to the data compressing unit 5 so as to compress the band data in the direction from the end address to the head address of the selected drawing bands. By this instruction, the data compressing unit 5 calculates the addresses sequentially from the end address of the object band, and selects the significant bit upon start of processing (step S107).

Next, the data compressing unit 5 compresses sequentially in the direction from the end address to the head address (step S108).

When not turning upside down in the process at step S106, the compression direction determining unit 4 sends an instruction to the data compressing unit 5 so as to compress the band data in the direction from the head address to the end address of the selected drawing bands. The data compressing unit 5 compresses the band data sequentially in the direction from the memory head address to the end (step S109).

After compressing all drawing bands, the band selecting unit 3 judges again whether or not to turn the printing data upside down (step S110).

When turning upside down, the band selecting unit 3 selects the drawing bands to be processed next in ascending order (step S111).

When not turning upside down, the band selecting unit 3 selects the drawing bands to be processed next in descending order (step S112).

Back to step S105, the band selecting unit 3 issues the information of the memory head address, main scanning width and sub scanning width, of the memory in which the drawing band of the next object band is stored, to the data compressing unit 5.

Similarly, the drawing bands are sequentially compressed.

Thus, according to embodiment 1, the data reversing for upside-down print is done simultaneously with compression process in the drawing band unit. That is, the data is compressed on the assumption of upside-down print. Therefore, it is applicable to variable length compression method.

(Embodiment 2)

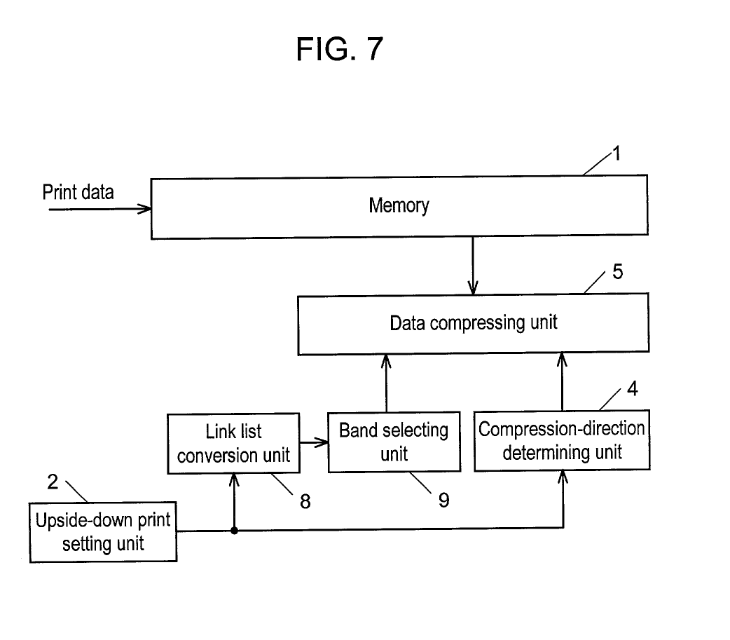

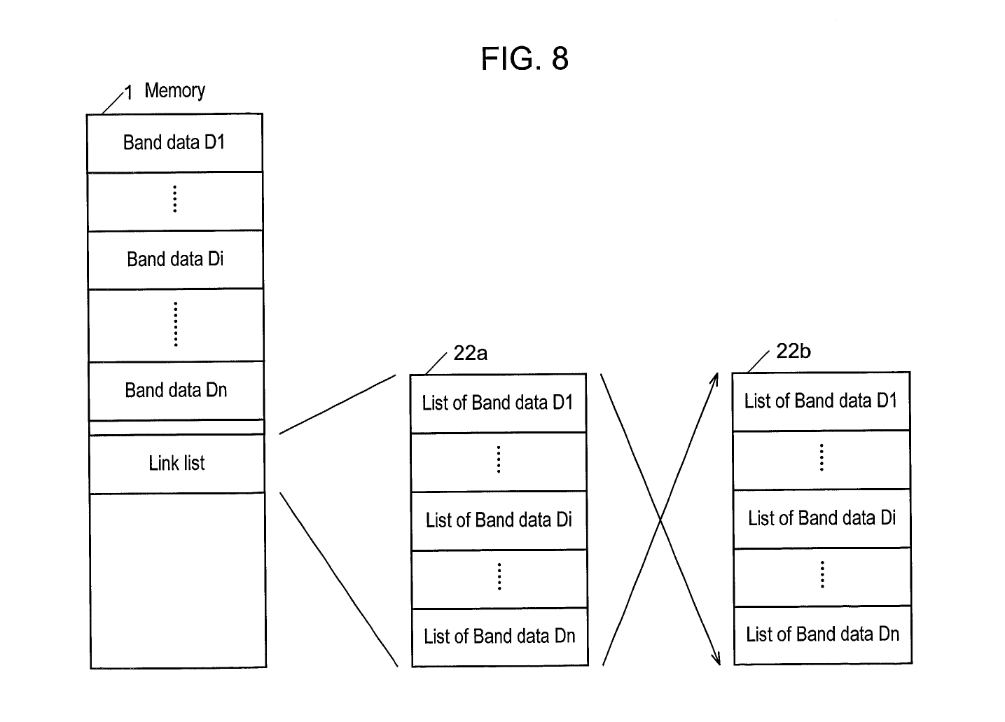

FIG. 7 is a block diagram of an image processing apparatus in embodiment 2 of the invention, and FIG. 8 is an explanatory diagram of link list of the same.

In embodiment 2, the image processing apparatus is constituted of the same elements as in embodiment 1, and includes a memory 1, an upside-down print setting unit 2, a band selecting unit 9, a compression direction determining unit 4, and a data compressing unit 5. The image processing apparatus further includes a link list conversion unit 8.

The upside-down print setting unit 2 and band selecting unit 9 are connected to the link list conversion unit 8.

The link list conversion unit 8 generates a link list while reversing the arrangement of drawing bands every time a drawing band is processed.

Printing data sequentially transferred from an external device is, in the same way as in embodiment 1, developed into a bit map by a rasterizer. At this time, the printing data is developed by the rasterizer into bit map data of each one of the plural drawing bands as shown in FIG. 8. The bit map data is stored again in the memory 1 as band data D1 to band data Dn.

The attribute of each drawing band required in later process is stored in the memory 1.

In embodiment 2, the memory head address, the main scanning width and sub scanning width, which are the attributes of each drawing band are compiled as a list, and held in batch as link list 22a by piling up lists as shown in the center in FIG. 8.

In the case that upside-down print is made according to instruction from the upside-down print setting unit 2 setting whether to perform upside-down print or not, the link list conversion unit 8 generates a link list 22b while reversing the arrangement of drawing bands every time a drawing band is processed as shown at the right side in FIG. 8.

In this case, the band selecting unit 9 refers to the link list 22b sequentially according to the arrangement of drawing bands in the link list 22b, and issues the band information of the drawing band, specifically, the memory head address in which the band data is stored, and the main scanning width and sub scanning width, to the data compressing unit 5.

Based on the information from the upside-down print setting unit 2, the compression direction determining unit 4 determines whether the data in the drawing band is compressed from the head or from the end, and transfers the result as the compression direction to the data compressing unit 5.

The data compressing unit 5 compresses the bit map data according to the information from the band selecting unit 9 and compression direction determining unit 4.

Thus, embodiment 2 is also applicable to the variable length compression method because data conversion for upside-down print is executed simultaneously with the compression process in each drawing band.

(Embodiment 3)

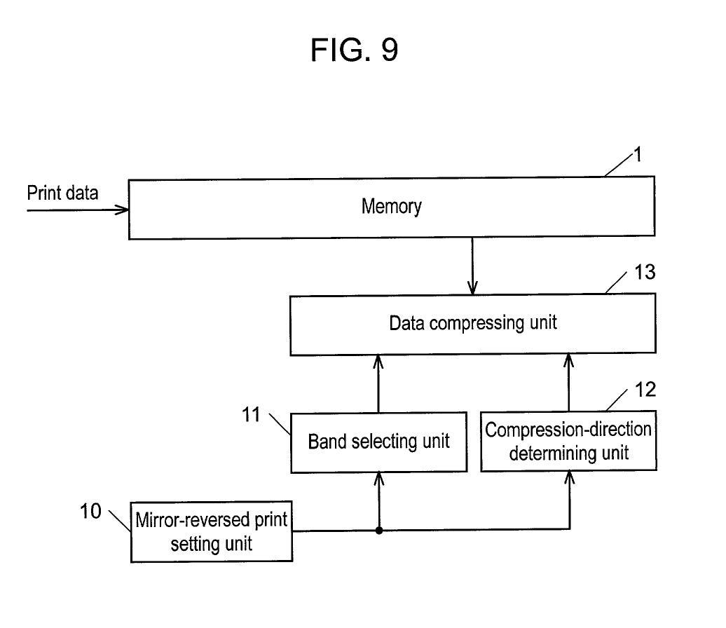

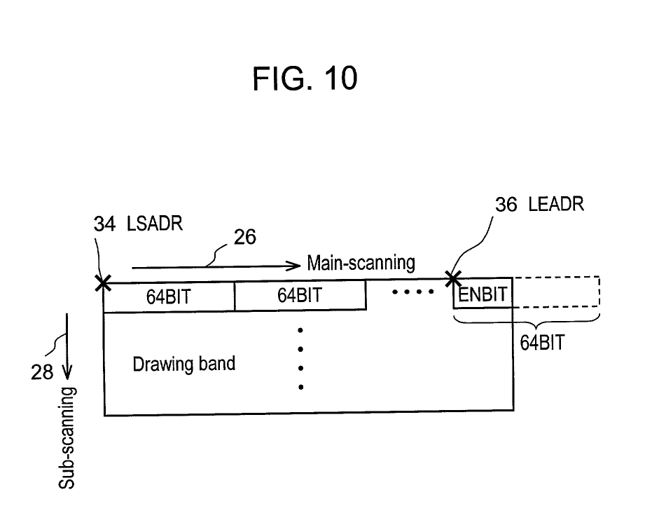

FIG. 9 is a block diagram of an image processing apparatus in embodiment 3 of the invention, and FIG. 10 is an explanatory diagram showing mirror-reversed drawing bands in a data compressing unit provided in the image processing apparatus.

In embodiment 3, the image processing apparatus includes a memory 1, a band selecting unit 11, a compression direction determining unit 12, a data compressing unit 13, and a mirror-reversed print setting unit 10. What differs from embodiment 1 or 2 is that the mirror-reversed print setting unit 10 is provided instead of the upside-down print setting unit 2.

The compression direction determining unit 4 is connected to the mirror-reversed print setting unit 10. This mirror-reversed print setting unit 10 determines whether to perform mirror-reversed print or not.

Printing data sequentially transferred from an external device is, in the same way as in embodiment 1, stored as band data, as shown in FIG. 2, in the memory 1 as band data D1 to band data Dn.

In the same way as in embodiment 1, the memory head address as, the main scanning width and sub scanning width, which are the attributes of each drawing band, are compiled as a list, and held in batch as link list by piling up lists as shown in FIG. 2.

According to the information from the mirror-reversed print setting unit 10 for setting mirror-reversed printing, the compression direction determining unit 12 determines whether the compression is made from the line head or from the line end in every main scanning line in the drawing band, and transfers the result as the compression direction to the data compressing unit 13.

The band selecting unit 11, while sequentially referring to the link list according to the arrangement of the drawing band of the link list, issues the band information of the drawing band, specifically the memory head address in which the band data is stored, and the main scanning width and sub scanning width, to the data compressing unit 13.

The data compressing unit 13 compresses the bit map data according to the information from the band selecting unit 11 and compression direction determining unit 12.

In this embodiment, too, the data compressing unit 13 includes a data acquiring unit 6 and a compression processing unit 7 shown in FIG. 3, in the same way as the data compressing unit 5 in embodiment 1.

Herein, calculation of line end address and conversion of bit sequence are executed as follows.

First refer to the drawing band 24 shown in FIG. 10.

In the memory 1, data is handled in 64-bit data width. A line head address 34 is LSADR, a line end address 36 is LEADR, the main scanning width is WIDTH, and the sub scanning width is HEIGHT. The bit map data is supposed to be stored in the memory in plane sequence in each color. Herein, an arrow 26 shows the main-scanning direction, and an arrow 28 indicates a sub-scanning direction.

LEADR is calculated in formula 2.

LEADR=LSADR+(WIDTH/64)×8−1 (2)

where the division result of WIDTH/64 is obtained as an integer by rounding up the decimal, while the remainder of the division result is held as ENBIT.

Next, as shown in FIG. 4, for conversion of bit sequence, the arrangement of data acquired from the memory is reversed, and the bit sequence is converted. Further, the value of ENBIT is issued to the compression processing unit 7 shown in FIG. 3 as the significant bit data from the 64-bit data acquired only upon the start of processing as shown in FIG. 10.

The compression processing unit 7 sequentially compresses the data from the data acquiring unit 6 in FIG. 3. At this time, the compression processing unit 7 selects significant bits according to the ENBIT value from the data acquiring unit 6 only upon the start of processing, and compresses on the selected data alone.

Thus, embodiment 3 is also applicable to the variable length compression method because data conversion for mirror-reversed print is executed simultaneously with the compression process in each drawing band.

(Embodiment 4)

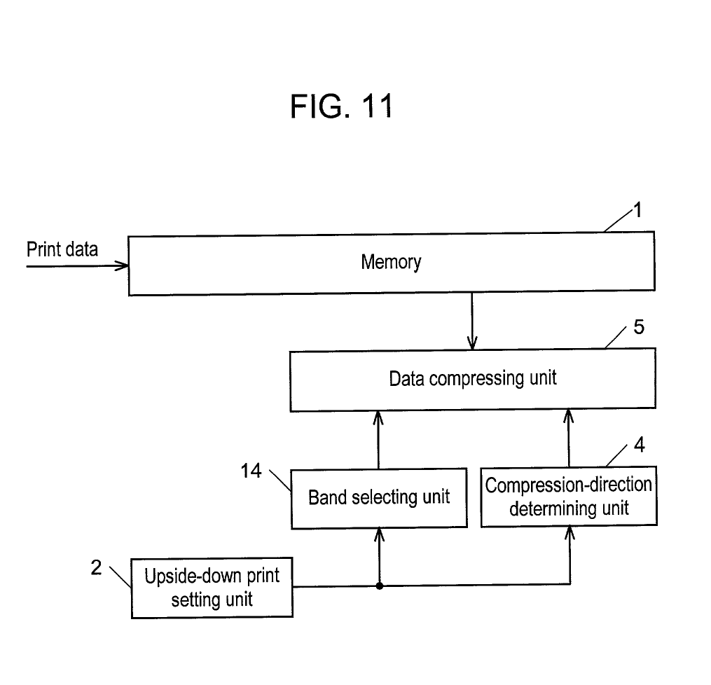

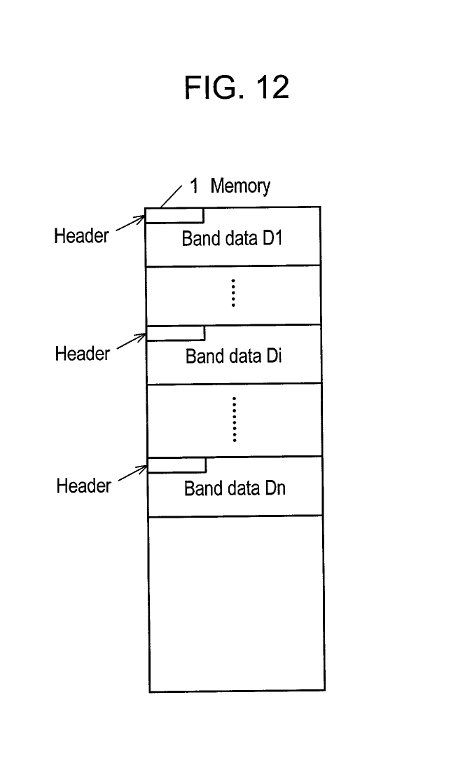

FIG. 11 is a block diagram of an image processing apparatus in embodiment 4 of the invention, and FIG. 12 is a storage map of band data and header in embodiment 4 of the invention.

In embodiment 4, the image processing apparatus is constituted of the same elements as in embodiment 1, and includes a memory 1, an upside-down print setting unit 2, a band selecting unit 14, a compression direction determining unit 4, and a data compressing unit 5.

The band selecting unit 14 determines the sequence of drawing bands to be processed out of plural drawing bands, and issues the band information of the selected drawing band while referring to the header according to the sequence to the data compressing unit 5.

Printing data sequentially transferred from an external device is, same as in embodiment 1, developed by a rasterizer into bit map data of each one of the plural drawing bands. The bit map data is stored again in the memory 1 as band data as shown in FIG. 12.

The attribute of each drawing band required in later process is stored in the memory 1. As the attributes of each drawing band, the memory head address, main scanning width and sub scanning width are held in the header or footer of each drawing band.

In embodiment 4, these attributes are held in the header as shown in FIG. 12. According to instruction from the upside-down print setting unit 2 setting whether to perform upside-down print or not, the band selecting unit 14 determines the sequence of drawing bands to be processed out of plural drawing bands. Further, the band selecting unit 14, based on the sequence, refers to the header of each drawing band, and issues the band information of the selected drawing band, specifically the memory head address in which the band data is stored, and the main scanning width and sub scanning width, to the data compressing unit 5.

By the instruction from the upside-down print setting unit 2, the compression direction determining unit 4 determines whether the data in the drawing band is compressed from the head or from the end, and transfers the result as the compression direction to the data compressing unit 5.

The data compressing unit 5 compresses the bit map data according to the information from the band selecting unit 14 and compression direction determining unit 4.

Thus, embodiment 4 is also applicable to the variable length compression method because data conversion for upside-down print is executed simultaneously with the compression process in drawing band unit.

(Embodiment 5)

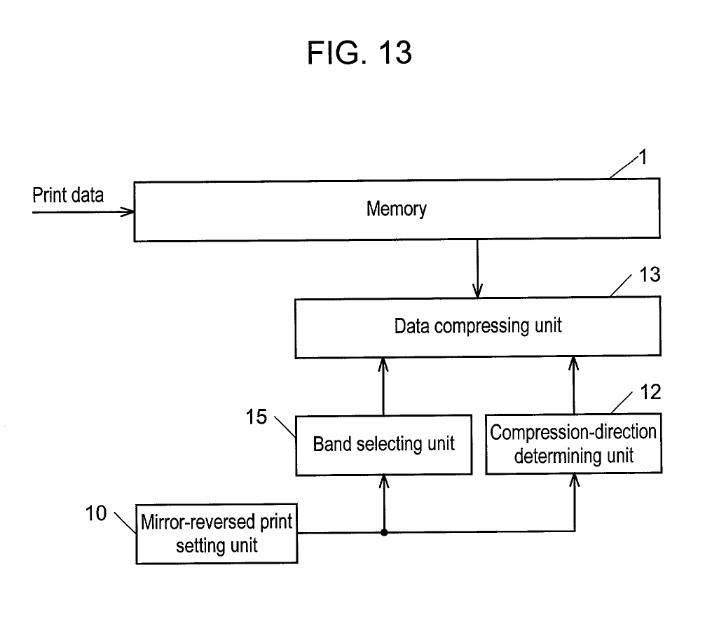

FIG. 13 is a block diagram of an image processing apparatus in embodiment 5 of the invention.

In embodiment 5, in the same way as in embodiment 3, the image processing apparatus includes a memory 1, a mirror-reversed print setting unit 10, a compression direction determining unit 12, a data compressing unit 13, and a band selecting unit 15.

Printing data sequentially transferred from an external device is, in the same way as in embodiment 3, developed by a rasterizer into a bit map in plural drawing band units. The bit map data is stored again in the memory 1 as band data as shown in FIG. 12.

At this time, in the same way as in embodiment 4, as the attributes of each drawing band, the memory head address, main scanning width and sub scanning width are held in the header or footer of each drawing band.

In embodiment 5, too, these attributes are held in the header as shown in FIG. 12.

According to the arrangement of drawing bands in the header, the band selecting unit 15 refers to the header sequentially, and issues the band information of the drawing band, specifically the memory head address, the main scanning width and sub scanning width of the memory in which the band data is stored, to the data compressing unit 13.

Based on the information from the mirror-reversed print setting unit 10 for setting mirror-reversed printing, the compression direction determining unit 12 determines whether the compression is made from the line head or from the line end in each main scanning line in the drawing band, and transfers the result as the compression direction to the data compressing unit 13.

The data compressing unit 13 compresses the bit map data according to the information from the band selecting unit 15 and compression direction determining unit 12.

Thus, embodiment 5 is also applicable to the variable length compression method because data conversion for mirror-reversed print is executed simultaneously with the compression process in drawing band unit.

What is claimed is:

1. An image processing apparatus for interpreting printing data, and developing said printing data into bit map data in plural drawing bands comprising:
(a) an upside-down print setting unit for setting upside-down printing for reversed printing from an end drawing band to a head band among said plural drawing bands,
(b) a band selecting unit for selecting a drawing band among said plural drawing bands based upon information from the upside-down print setting unit while referring to a link list having arrangement information of said plural drawing bands,
(c) a compression direction determining unit for determining sequence of compression of bit map data in a drawing band among said plural drawing bands based upon information from the upside-down print setting unit, and
(d) a data compressing unit for compressing data of the selected drawing band selected by the band selecting unit according to the sequence determined by the compression direction determining unit.

2. An image processing apparatus for interpreting printing data, and developing said printing data into bit map data in plural drawing bands comprising:
(a) an upside-down print setting unit for setting upside-down printing for reversed printing from an end drawing band to a head band among said plural drawing bands,
(b) a link list conversion unit for reversing arrangement of said plural drawing bands of a link list having arrangement information of said plural drawing bands, in the case of upside-down print base upon information from the upside-down print setting unit,
(c) a band selecting unit for selecting a drawing band among said plural drawing bands by referring to the link list,
(d) a compression direction determining unit for determining sequence of compression of bit map data in a drawing band among said plural drawing bands based upon information from the upside-down print setting unit, and
(e) a data compressing unit for compressing data of the selected drawing band selected by the band selecting unit according to sequence determined by the compression direction determining unit.

3. An image processing apparatus for interpreting printing data, and developing said printing data into bit map data in plural drawing bands comprising:
(a) a mirror-reversed print setting unit for setting mirror-reversed printing by decompressing compressed data sequentially from a line end address of each of said plural drawing bands,
(b) a band selecting unit for selecting a drawing band among said plural drawing bands by referring to a link list having arrangement information of said plural drawing bands,
(c) a compression direction determining unit for determining sequence of compression of bit map data in a drawing bands among said plural drawing bands based upon information from the mirror-reversed print setting unit, and
(d) a data compressing unit for compress ing data of the selected drawing band selected by the band selecting unit according to the sequence determined by the compression direction determining unit.

4. An image processing apparatus for interpreting printing data, and developing said printing data into bit map data in plural drawing bands comprising:
(a) an upside-down print setting unit for setting upside-down printing for reversed printing from an end drawing band to a head band among said plural drawing bands,
(b) a band selecting unit for selecting a drawing band among said plural drawing bands based upon information from the upside-down print setting unit, while referring to one of a header and a footer of each of said plural drawing bands having arrangement information of said each of said plural drawing bands,
(c) a compression direction determining unit for determining sequence of compression of bit map data in a drawing band among said plural drawing bands based upon information from the upside-down print setting unit, and
(d) a data compressing unit for compressing data of the selected drawing band selected by the band selecting unit according to the sequence determined by the compression direction determining unit.

5. An image processing apparatus for interpreting printing data, and developing said printing data into bit map data in plural drawing bands comprising:
(a) a mirror-reversed print setting unit for setting mirror-reversed printing by decompressing compressed data sequentially from a line end address of each of said plural drawing bands,
(b) a band selecting unit for selecting a drawing band among said plural drawing bands by referring to one of a header and a footer of each of said plural drawing bands having arrangement information of said each of plural drawing bands,
(c) a compression direction determining unit for determining sequence of compression of bit map data in a drawing band among said plural drawing bands based upon information from the mirror-reversed print setting unit, and
(d) a data compressing unit for compressing the data of the selected drawing band selected by the band selecting unit according to the sequence determined by the compression direction determining unit.

6. The image processing apparatus of claim 1, wherein said data compressing unit includes:
i) a data acquiring unit for acquiring the bit map data from a memory based upon the arrangement information and the sequence of compression, and
ii) a compression processing unit for compressing the bit map data received from the data acquiring unit.

7. An image processing method for interpreting printing data, and developing said printing data into bit map data in plural drawing bands comprising the steps of:
(a) setting upside-down printing for reversed printing from an end drawing band to a head band among said plural drawing bands,
(b) selecting a drawing band among said plural drawing bands based upon setting at step (a) while referring to a link list having arrangement information of said plural drawing bands,
(c) determining sequence of compression of bit map data in a drawing band among said plural drawing bands based upon setting at step (a), and
(d) compressing data of the selected drawing band at step (b) according to the sequence of compression.

8. An image processing method for interpreting printing data, and developing said printing data into bit map data in plural drawing bands comprising the steps of:
(a) setting upside-down printing for reversed printing from an end drawing band to a head band among said plural drawing bands,
(b) reversing arrangement of said plural drawing bands of a link list having arrangement information of said plural drawing bands, in the case of upside-down print based upon setting at step (a),
(c) selecting a drawing band among said plural drawing bands by referring to the link list,
(d) determining sequence of compression of bit map data in a drawing band among said plural drawing bands based upon setting at step (a), and
(e) compressing data of the selected drawing band at step (c) according to the sequence of compression.

9. An image processing method for interpreting printing data, and developing said printing data into bit map data in plural drawing bands comprising the steps of:
(a) setting mirror-reversed printing by decompressing compressed data sequentially from a line end address of each of said plural drawing bands,
(b) selecting a drawing band among said plural drawing bands by referring to a link list having arrangement information of said plural drawing bands,
(c) determining sequence of compression of bit map data in the drawing bands based upon setting at step (a), and
(d) compressing data of the selected drawing band at step (b) according to the sequence of compression.

10. An image processing method for interpreting printing data, and developing said printing data into bit map data in plural drawing bands comprising the steps of:
(a) setting upside-down printing for reversed printing from an end drawing band to a head band among said plural drawing bands,
(b) selecting a drawing band among said plural drawing bands based upon setting at step (a), while referring to one of a header and a footer of each of said plural drawing bands having arrangement information said each of said plural drawing bands,
(c) determining the sequence of compression of bit map data in a drawing band among said plural drawing bands base upon setting at step (a), and
(d) compressing data of the selected drawing band at step (b) according to the sequence of compression.

11. An image processing method for interpreting printing data, and developing said printing data into bit map data in plural drawing bands comprising the steps of:
(a) setting mirror-reversed printing by decompressing the compressed data sequentially from a line end address of each of said plural drawing bands,
(b) selecting a drawing band among said plural drawing bands by referring to one of a header and a footer of said each of said drawing band having arrangement information of said plural drawing bands,
(c) determining sequence of compression of bit map data in a drawing band among said plural drawing bands based upon setting at step (a), and
(d) compressing the data of the selected drawing band at step (b) according to the sequence of compression.

12. The image processing method of claim 7, wherein said compressing steps includes the steps of:
i) acquiring the bit map data from a memory based upon the arrangement information and the sequence of compression, and
ii) compressing the bit map data.

13. The image processing apparatus of claim 2, wherein said data compressing unit includes:
i) a data acquiring unit for acquiring the bit map data from a memory based upon the arrangement information and the sequence of compression, and
ii) a compression processing unit for compressing the bit map data received from the data acquiring unit.

14. The image processing apparatus of claim 3, wherein said data compressing unit includes:
i) a data acquiring unit for acquiring the bit map data from a memory based upon the arrangement information and the sequence of compression, and
ii) a compression processing unit for compressing the bit map data received from the data acquiring unit.

15. The image processing apparatus of claim 4, wherein said data compressing unit includes:
i) a data acquiring unit for acquiring the bit map data from a memory based upon the arrangement information and the sequence of compression, and
ii) a compression processing unit for compressing the bit map data received from the data acquiring unit.

16. The image processing apparatus of claim 5, wherein said data compressing unit includes:
i) a data acquiring unit for acquiring the bit map data from a memory based upon the arrangement information and the sequence of compression, and
ii) a compression processing unit for compressing the bit map data received from the data acquiring unit.

17. The image processing method of claim 8, wherein said compressing steps includes the steps of:
i) acquiring the bit map data from a memory based upon the arrangement information and the sequence of compression, and
ii) compressing the bit map data.

18. The image processing method of claim 9, wherein said compressing steps includes the steps of:
i) acquiring the bit map data from a memory based upon the arrangement information and the sequence of compression, and
ii) compressing the bit map data.

19. The image processing method of claim 10, wherein said compressing steps includes the steps of:
i) acquiring the bit map data from a memory based upon the arrangement information and the sequence of compression, and
ii) compressing the bit map data.

20. The image processing method of claim 11, wherein said compressing steps includes the steps of:
i) acquiring the bit map data from a memory based upon the arrangement information and the sequence of compression, and
ii) compressing the bit map data.
